(19) United States
(12) Patent Application Publication
(10) Pub. No.: US 2008/0289938 A1
(43) Pub. Date: Nov. 27, 2008

(54) Reduced material plug-on jaw with symmetrical spring for a circuit breaker

(75) Inventors: Rodney D. Raabe, Swisher, IA (US); David K. Schroeder, Marion, IA (US)

Correspondence Address: SCHNEIDER ELECTRIC / SQUARE D COMPANY;LEGAL DEPT. - I.P. GROUP (NP), 1415 S. ROSELLE ROAD, PALATINE, IL, 60067, US

(73) Assignee: Square D Company

(21) Appl. No.: 11/805,200

(22) Filed: May 22, 2007

(51) Int. Cl. H01H 1/00; H01H 11/00; H01H 33/02

(52) U.S. Cl. 200/238; 200/237; 29/622

(57) ABSTRACT

A circuit breaker includes a stationary contact, a plug-on half jaw, and a jaw spring. The plug-on half jaw is electrically coupled to the stationary contact and has a single terminal end for receiving a bus bar. The jaw spring is operatively coupled to the half jaw and has a bridge portion connecting two symmetrical spring legs.

### FIELD OF THE INVENTION

This invention is directed generally to an electrical circuit breaker, and, more particularly, to a plug-on half jaw and symmetrical jaw spring for a circuit breaker.

### BACKGROUND OF THE INVENTION

Circuit breakers are well known in the art, and are designed to trip in response to an electrical interruption event caused by an overload, short circuit, or thermal runaway condition, thereby opening the circuit to which the circuit breaker is connected and reducing the possibility of damage to the conductor wires or the loads connected to the circuit breaker. A circuit breaker can be reset (either manually or automatically) to resume power flow to the loads.

Some circuit breakers contain a plug-on full jaw, which is made of copper, that is coupled with a jaw spring for mechanically securing a bus bar to the circuit breaker. The full jaw also electrically couples the bus bar to a stationary contact of the circuit breaker. One problem associated with the full jaw is that its inherent design of having two terminal ends considerably increases the material cost.

What is needed, therefore, is a circuit breaker having a plug-on device that reduces material cost.

### SUMMARY OF THE INVENTION

In one implementation, a circuit breaker includes a stationary contact, a plug-on half jaw, and a jaw spring. The plug-on half jaw is electrically coupled to the stationary contact and has a single terminal end for receiving a bus bar. The jaw spring is operatively coupled to the half jaw and has a bridge portion connecting two symmetrical spring legs.

In an alternative implementation, a method of assembly for a circuit breaker includes electrically coupling a plug-on half jaw to a stationary contact, the half jaw having a single terminal end for receiving a bus bar. The half jaw is mounted in a circuit breaker base. A jaw spring is inserted into the circuit breaker base for operatively coupling the jaw spring to the half jaw. The jaw spring has two symmetrical spring legs, one of the spring legs mechanically cooperating with the single terminal end of the half jaw to apply sliding contact pressure when receiving the bus bar.

In another alternative implementation, a circuit breaker assembly includes a base for receiving internal components of a circuit breaker and a cover for at least partially enclosing the internal components. A half jaw is mounted to the base and has a stationary contact. The half jaw is in electrical contact with the stationary contact and has a single terminal end for electrically contacting a bus bar. A jaw spring is mounted to the base and is operatively coupled to the half jaw. Further, the jaw spring has two symmetrical legs, one of the legs forming a terminal receiving gap with the terminal end for receiving the bus bar.

Additional aspects of the invention will be apparent to those of ordinary skill in the art in view of the detailed description of various implementations, which is made with reference to the drawings, a brief description of which is provided below.

### BRIEF DESCRIPTION OF THE DRAWINGS

The invention may best be understood by reference to the following description taken in conjunction with the accompanying drawings, in which:

FIG. 1 is a perspective view illustrating a circuit breaker containing a half jaw and a symmetrical jaw spring according to one embodiment;

FIG. 2A is a perspective view of the jaw spring;

FIG. 2B is a side view of the jaw spring;

FIG. 3A is a perspective view of the half jaw;

FIG. 3B is a top view of the half jaw;

FIG. 3C is a front view of the half jaw;

FIG. 3D is a side view of the half jaw;

FIG. 4 is an exploded partial perspective view illustrating the assembly of the half jaw and the jaw spring to a circuit breaker base, according to an alternative embodiment; and

FIG. 5 is an enlarged perspective view illustrating the insertion of a bus bar into the circuit breaker, according to an alternative embodiment.

### DETAILED DESCRIPTION OF THE ILLUSTRATED EMBODIMENTS

Although the invention will be described in connection with certain preferred embodiments, it will be understood that the invention is not limited to those particular embodiments. On the contrary, the invention is intended to include all alternatives, modifications and equivalent arrangements as may be included within the spirit and scope of the invention as defined by the appended claims.

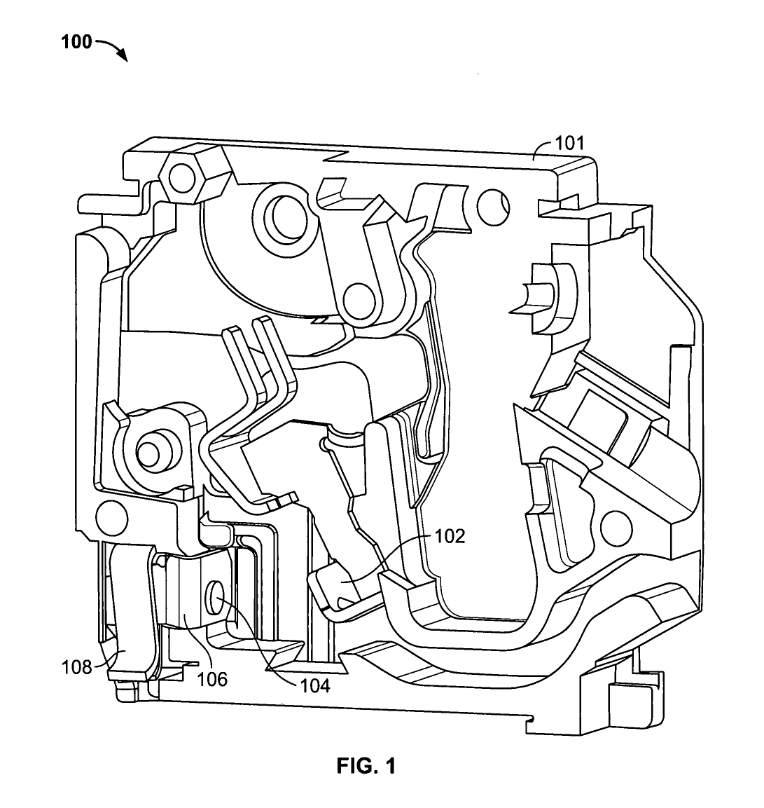

Turning now to FIG. 1, a circuit breaker 100 includes a base 101 that has mountable positions for receiving a plurality of internal breaker components, including a movable contact 102, a stationary contact 104, a half jaw 106, and a jaw spring 108. In general, most components of the circuit breaker 100 are installed on the base 101 and secured therein after a cover (not shown) is attached to the base 101.

The circuit breaker 100 has several positions, including an ON position, a TRIPPED position, and an OFF position. When the circuit breaker 100 is in the ON position, current flows unrestricted through the circuit breaker 100 and, therefore, through the electrical device or circuit that the circuit breaker is designed to protect. In the ON position, the movable contact 102 is in direct contact with the stationary contact 104.

When the circuit breaker 100 is in the TRIPPED position, current flow through the circuit breaker 100 is interrupted and, consequently, current does not flow through the electrical device or circuit that the circuit breaker is designed to protect. The TRIPPED position is caused by the presence of a current higher than the rated current for the circuit breaker 100 over a specified period of time. When the circuit breaker 100 is in the OFF position, current flow is generally manually interrupted from flowing through the circuit breaker 100. In the TRIPPED and OFF positions the movable contact 102 is separated from the stationary contact 104.

The movable contact 102 is operatively coupled to a trip unit and a switching mechanism (not shown) to interrupt electrical contact when a trip condition occurs. The exposure of the circuit breaker 100 over the specified period of time to a current that exceeds the rated current by a predetermined threshold activates a tripping mechanism. Activation of the tripping mechanism causes the switching mechanism to interrupt current flow through the circuit breaker 100 by separating the movable contact 102 from the stationary contact 104. In FIG. 1, the movable contact 102 is illustrated separated from the stationary contact 104.

The stationary contact 104 is mechanically and electrically coupled to the half jaw 106. Specifically, the stationary contact 104 is a small circular cylinder that is mechanically secured directly to the half jaw 106. The half jaw 106 is inserted into a respective mounting location on the base 100, and the jaw spring 108 is inserted in a partially overlapping position relative to the half jaw 106.

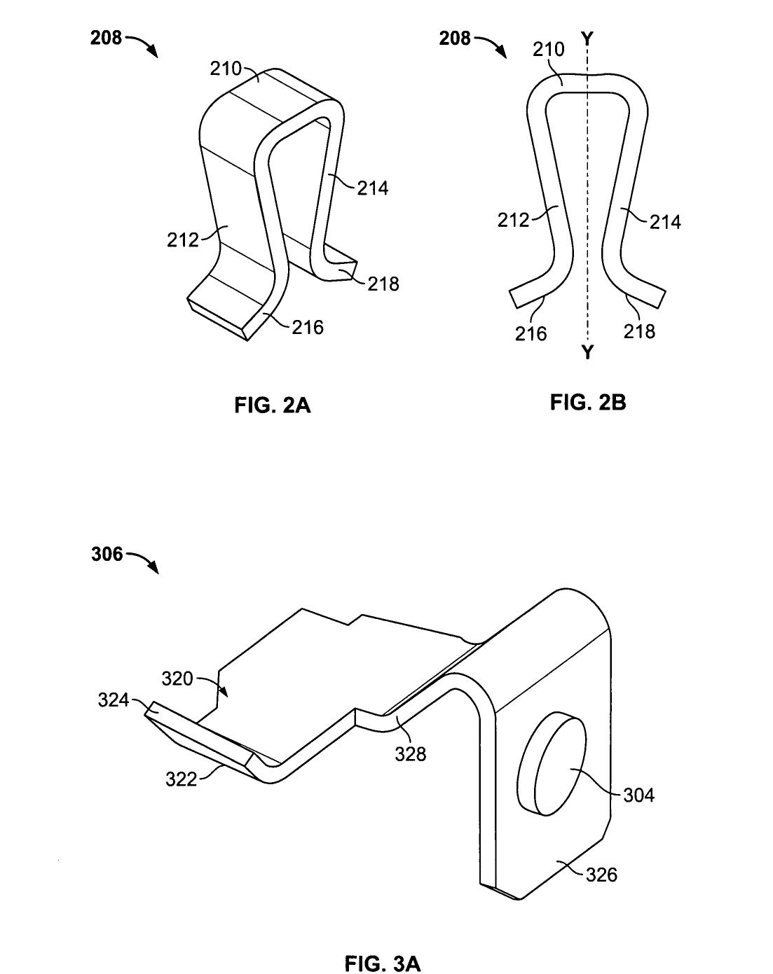

FIGS. 2A and 2B illustrate a jaw spring 208 in accordance with one implementation of the present invention. According to one embodiment, the jaw spring 208 is a hairpin spring made from a hardened steel material. The jaw spring 208 has a bridge portion 210 centrally located between two spring legs 212, 214. The spring legs 212, 214 are symmetrical about a Y-axis of the jaw spring 208. At the end of each spring leg 212, 214, the jaw spring 208 has an angled receiving surface 216, 218 symmetrically angled about the Y-axis.

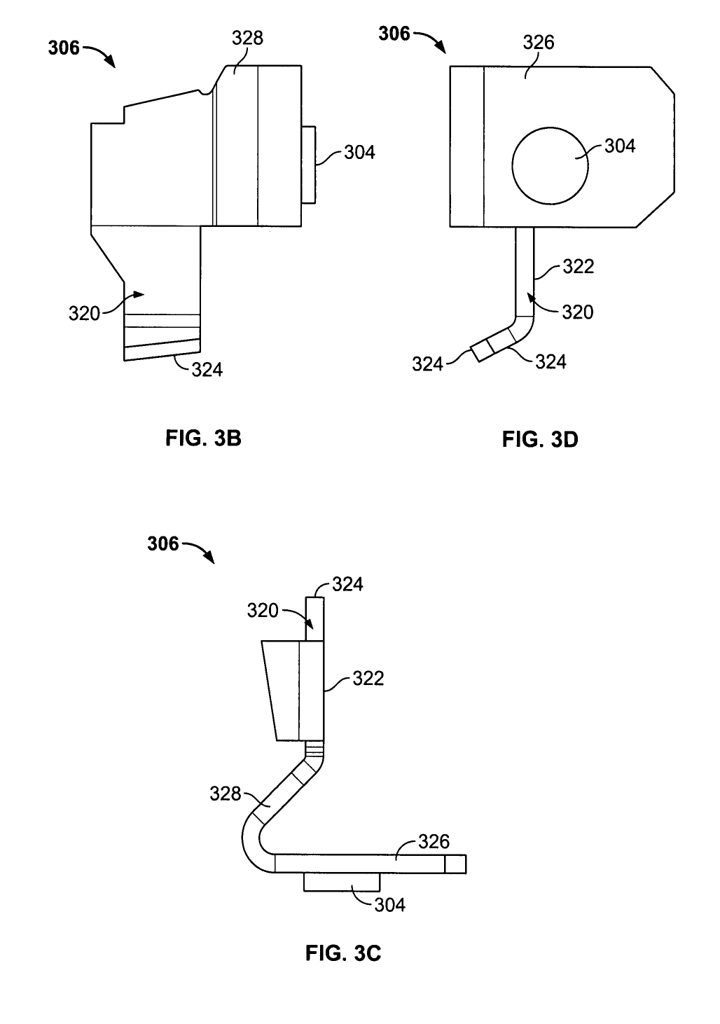

FIGS. 3A-3D illustrate a stationary contact 304 connected to a half jaw 306 in accordance with another embodiment. The half jaw 306 is a plug-on type jaw for electrically coupling the circuit breaker, in which it is mounted, to a bus bar. The half jaw 306 has a single terminal end 320 and an internal surface 322, which makes direct contact with the bus bar. According to an alternative embodiment, the half jaw 306 is made from a copper material.

The half jaw 306 inherently provides a reduction in necessary material because it has only one (i.e., a single) terminal end 320. Thus, in contrast to a full jaw (which has two terminal ends), the half jaw 306 considerably reduces the associated material cost.

The single terminal end 320 has an end portion 324 proximate the internal surface 322. The end portion 324 is angled in a direction away from the bus bar, to reduce the possibility of mechanical interference when inserting the bus bar.

The half jaw 306 also has a contact end 326 on which the stationary contact 304 is mechanically and electrically secured. The contact end 326 is connected to the single terminal end 320 via a connecting surface 328, which is generally angled downwards from a top end of the contact end 326. The contact end 326 is positioned generally perpendicular to the single terminal end 320.

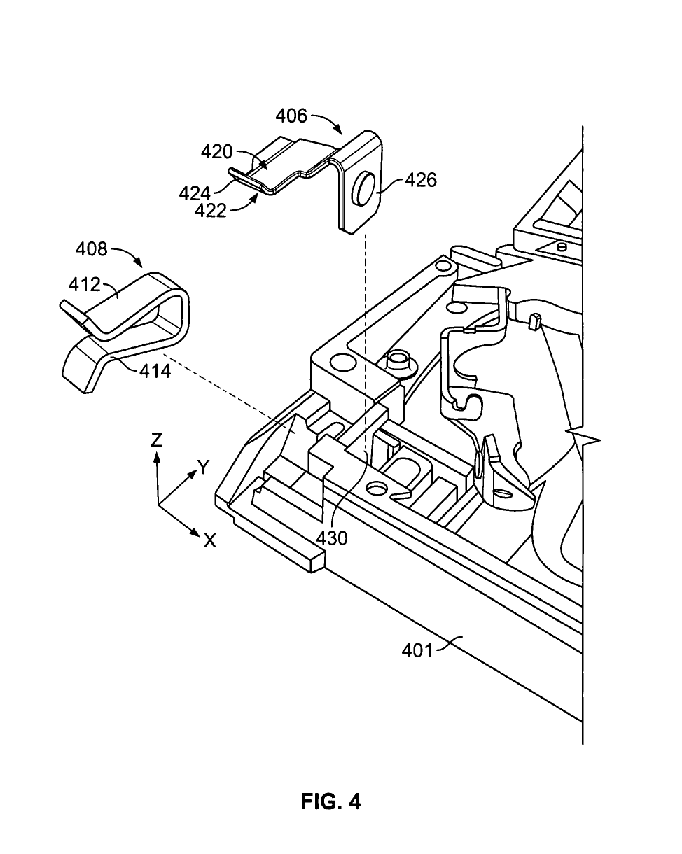

FIG. 4 illustrates the assembly of a half jaw 406 and a jaw spring 408 to a circuit breaker base 401. The half jaw 406 is inserted along a Z-axis direction into its respective mounting position on the base 401. A contact end 426 of the half jaw 406 slides in over a supporting surface 430 of the circuit breaker base 401. A single terminal end 420 is oriented with its end portion 424 angled away, along the Z-axis direction, from the circuit breaker base 401.

After the half jaw 406 is mounted to the base 401, the jaw spring 408 is inserted along an X-axis direction into its respective position on the circuit breaker base 401. Specifically, an internal surface of one of its two spring legs 412, 414 is positioned in direct contact with an internal surface 422 of the half jaw 406. Thus, the jaw spring 408 partially overlaps the half jaw 406 when mounted in its respective position on the circuit breaker base 401. Because the jaw spring 408 is symmetrical, the orientation of its spring legs 412, 414 about the Y-axis direction is irrelevant. In other words, it is irrelevant whether a first spring leg 412 is up (away from the base 400 along the Z-axis direction) or down (towards the base 400 along the Z-axis direction). Thus, the symmetrical aspect of the jaw spring 408 reduces, or even eliminates, the need to include automated and/or manual assembly rejection features associated with the detection and removal of improperly assembled circuit breakers.

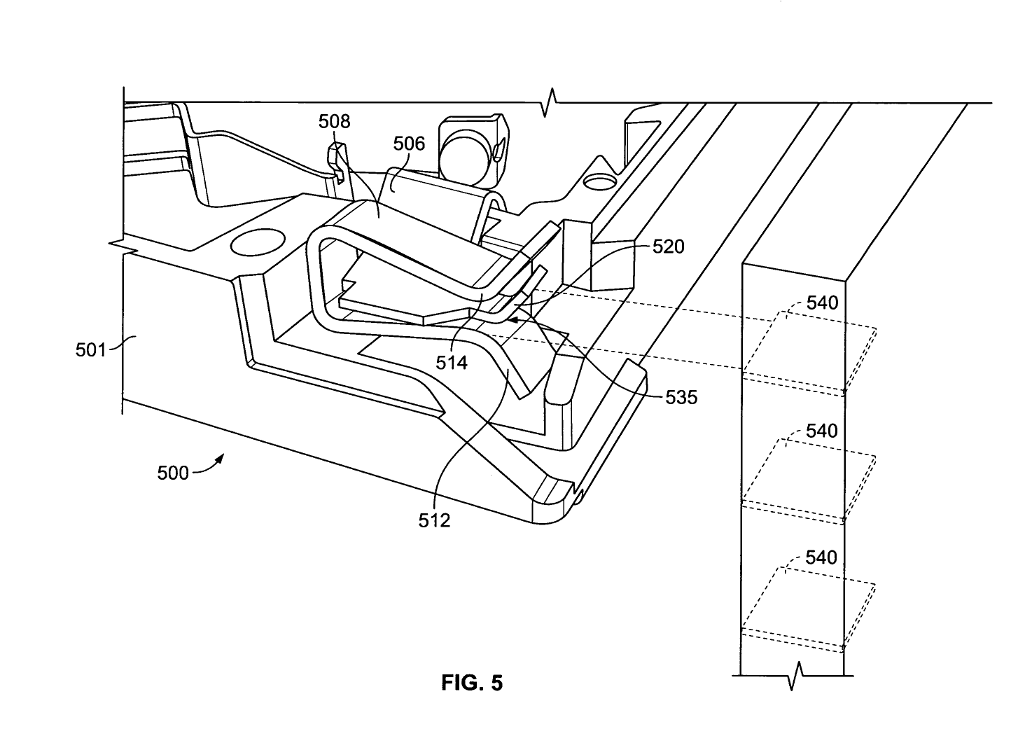

FIG. 5 illustrates a circuit breaker 500 being electrically connected to a bus bar 540. A base 501 of the circuit breaker 500 contains a half jaw 506 and a jaw spring 508 combination as described in more detail above in reference to FIGS. 1-4. The circuit breaker 500 is installed in the field by positioning it over a desired load center and sliding the bus bar 540 into a receiving gap 535 formed by the half jaw 506 and the jaw spring 508. The sliding contact pressure applied by the jaw spring 508 retains the circuit breaker in mechanical and electrical contact with the bus bar 540. More specifically, one spring leg 512 of the jaw spring 508 cooperates mechanically with a single terminal end 520 of the half jaw 506 and another spring leg 514 of the jaw spring 508 to mechanically hold the bus bar 540 securely in place with respect to the circuit breaker 500. In addition, the mechanical coupling of the bus bar 540 to the circuit breaker 500 provides electrical contact between the bus bar 540 and the half jaw 506.

While particular embodiments, aspects, and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

What is claimed is:

1. A circuit breaker comprising:
a stationary contact;
a plug-on half jaw electrically coupled to the stationary contact; the half jaw having a single terminal end for receiving a bus bar; and
a jaw spring operatively coupled to the half jaw, the jaw spring having a bridge portion connecting two symmetrical spring legs.

2. The circuit breaker of claim 1, wherein the stationary contact is mounted in direct contact with an internal surface of the half jaw, the internal surface being positioned proximate to a movable contact of the circuit breaker when the circuit breaker is in an ON position.

3. The circuit breaker of claim 1, wherein the jaw spring includes hardened steel.

4. The circuit breaker of claim 1, wherein the jaw spring is a hairpin spring.

5. The circuit breaker of claim 1, wherein the jaw spring includes two angled receiving surfaces, each of the receiving surfaces being positioned at an end of one of the spring legs, the receiving surfaces being symmetrically angled with respect to a central symmetry line of the jaw spring.

6. The circuit breaker of claim 1, wherein the single terminal of the half jaw includes an end surface, the end surface being angled such that it is generally parallel to a corresponding one of the receiving surfaces of the jaw spring.

7. The circuit breaker of claim 1, wherein one of the spring legs is positioned in an overlapping position over the single terminal end, another one of the spring legs is positioned opposite the single terminal end for applying sliding contact pressure to the bus bar.

8. The circuit breaker of claim 1, further comprising a base for receiving the half jaw and the jaw spring, the jaw spring being mountable to its base location independently of the half jaw.

9. The circuit breaker of claim 1, wherein the half jaw includes copper.

10. A method of assembly for a circuit breaker, the method comprising:
electrically coupling a plug-on half jaw to a stationary contact, the half jaw having a single terminal end for receiving a bus bar;
mounting the half jaw in a circuit breaker base; and
inserting a jaw spring into the circuit breaker base for operatively coupling the jaw spring to the half jaw, the jaw spring having two symmetrical spring legs, one of the spring legs mechanically cooperating with the single terminal end of the half jaw to apply sliding contact pressure when receiving the bus bar.

11. The method of claim 10, wherein the inserting of the jaw spring is performed after the mounting of the half jaw in the circuit breaker.

12. The method of claim 10, wherein the mounting of the half jaw includes insertion from a first axis direction, the inserting of the jaw spring being performed from a second axis direction.

13. The method of claim 10, further comprising positioning one of the spring legs opposite the single terminal end to form a gap between the one of the spring legs and the single terminal end.

14. The method of claim 10, wherein the sliding contact pressure includes securing mechanically and electrically the bus bar to the circuit breaker.

15. The method of claim 10, further comprising positioning the spring legs generally parallel to the single terminal end.

16. The method of claim 10, wherein at least one of the mounting and inserting is an automated assembly step.

17. A circuit breaker assembly comprising:
a base for receiving internal components of a circuit breaker;
a cover for at least partially enclosing the internal components;
a half jaw mounted to the base and having a stationary contact, the half jaw being in electrical contact with the stationary contact, the half jaw having a single terminal end for electrically contacting a bus bar; and
a jaw spring mounted to the base and operatively coupled to the half jaw, the jaw spring having two symmetrical legs, one of the legs forming a terminal receiving gap with the terminal end for receiving the bus bar.

18. The circuit breaker assembly of claim 17, wherein the jaw spring is a hardened steel hairpin spring.

19. The circuit breaker assembly of claim 17, wherein the half jaw includes copper.

20. The circuit breaker assembly of claim 17, wherein the jaw spring is mountable to its base location independently of the half jaw.
